(19) United States
(12) Patent Application Publication
(10) Pub. No.: US 2003/0072996 A1
(43) Pub. Date: Apr. 17, 2003

(54) Separation for a lithium ion secondary battery, method for producing the same, and a lithium ion secondary battery using the same

(76) Inventor: Whanjin Roh, Seoul (KR)

Correspondence Address: HARNESS, DICKEY & PIERCE, P.L.C., P.O. BOX 8910, RESTON, VA, 20195, US

(21) Appl. No.: 10/255,574

(22) Filed: Sep. 27, 2002

(30) Foreign Application Priority Data
Oct. 16, 2001 (KR) 2001-63761

(51) Int. Cl. H01M 2/16

(52) U.S. Cl. 429/144; 429/249; 429/250; 427/207.1

(57) ABSTRACT

This invention discloses a separator for a lithium secondary battery, method for producing thereof, and a lithium ion secondary battery using the thereof. The separator comprises a porous film including a polyolefin resin; and a coating solution coated on the porous film and containing a nonflammable compound and an adhesive resin for fixing the nonflammable compound. The lithium ion secondary battery manufactured by this invention provide an improved safety and better electrochemical performance such as charge/discharge characteristics and cycle life.

### BACKGROUND OF THE INVENTION

1. Field of the Invention

The present invention relates to a separator for a lithium ion secondary battery, method for producing the same, and a lithium ion secondary battery using the same, and more particularly, to a separator in which a coating solution containing nonflammable compound is coated on polyethylene base material with a weak heat resistance. The lithium ion secondary battery using the separator has an improved safety and better electrochemical performance such as charge/discharge characteristics, cycle life and so on.

2. Description of the Related Art

There is a growing demand for the miniaturization and lightening of portable electronic instruments, electrical bicycles, electrical vehicles and so on, and it is essential to improve performance of batteries to meet such a demand. Because of this, development and improvement of various batteries have been attempted in recent years with the aim of improving the battery performance. Expected characteristics of batteries to be improved include high voltage, large energy density, tolerance for large load resistance, safety at the high temperature and the like. Particularly, lithium ion battery is a secondary battery which can realize the highest voltage, largest energy density and tolerance for largest load resistance among existing batteries, and its improvement is still being made actively. Such lithium ion secondary battery is classified into three types, a liquid type battery using liquid electrolytes, a gel type battery using gel electrolytes mixed with polymer and liquid, and a solid type battery using polymer electrolytes, according to electrolytes to be used.

As its main composing elements, the lithium ion secondary battery has a positive electrode, a negative electrode, a separator positioned between these electrodes, an electrolyte and a packaging material.

The positive electrode is prepared by mixing powder of a positive active material with an electron conducting substance and a binder resin, and coating the mixture on an aluminum collector. The positive active material comprises Li-transition metal compound such as LiCoO₂, LiMn₂O₄, LiNiO₂, and LiMnO₂. The positive active material has a high electrochemical potential during intercalation/deintercalation reaction by lithium ion.

The negative electrode is prepared by mixing powder of a negative active material and a binder resin, and coating the mixture on a copper collector. The negative active material comprises lithium metal, carbonate, graphite and so on, and has a low electrochemical potential contrary to the positive active material.

The electrolyte is prepared by dissolving salt containing lithium ion such as LiCF₃SO₃, Li(CF₃SO₂)₂, LiPF₆, LiBF₄, LiClO₄, and LiN(SO₂C₂F₅)₂ in polar organic solvents such as ethylene carbonate, propylene carbonate, dimethyl carbonate, diethyl carbonate and methyl ethyl carbonate.

The separator comprises polyolefin polymer such as porous polyethylene or polypropylene, prevents electrical contact of the positive and negative electrodes, and provides a path of the lithium ion.

A packaging material comprises metal can or aluminum laminating sheet for protecting the cell and providing an electrical path.

The lithium ion secondary battery using liquid electrolyte has danger of explosion or fire by overcharge or careless use. In order to resolve such safety problem, and achieve compactness and flexibility for the size, development and improvement of lithium ion polymer battery using polymer as the electrolyte has been attempted. The lithium ion polymer battery has improved safety and size flexibility by using an aluminum laminating sheet as packaging material. The lithium ion polymer battery is prepared by impregnating polymer matrix into liquid electrolyte. As the polymer material, a variety of polymer materials have been proposed so far such as polyvinylidene fluoride, polyethylene oxide and polyacrylonitrile. For example, U.S. Pat. Nos. 5658685, 5639573, 5460904, 5837015 and 6124061 disclose lithium ion polymer battery and methods of fabricating thereof. But there are still problems for difficulty of manufacturing process in a large volume and safety in abnormal conditions.

The present invention has been accomplished as a result of intensive studies on the separator with the aim of satisfying the aforementioned problems.

The object of the present invention is to provide a separator of which surface is coated with nonflammable compounds-containing polymer solution in the lithium ion secondary batteries.

Another object of the present invention is to provide a method to produce the separator and a lithium ion secondary battery using the separator. The lithium ion battery according to the present invention provides improved safety, excellent charge/discharge characteristics and cycle life.

### SUMMARY OF THE INVENTION

A separator according to the present invention comprises a porous film including a polyolefin resin; and a coating solution coated on the porous film and containing a nonflammable compound and an adhesive resin for fixing the nonflammable compound.

The nonflammable compound comprises phosphorous-containing compound, halogen-containing compound, metal hydroxide-containing compound, antimony-containing compound, molybdenum-containing compound, zinc borate-containing compound and so on. Examples of the phosphorous-containing compound are triethylene phosphate, dimethyl methyl phosphonate, diphenyl crecyl phosphate, tris-chloro-ethyl phosphate, diethyl-N,N-bis-(2-hydroxyethyl)-aminomethyl phosphonate and dibutyl dihydroxyethyl diphosphate. In case of halogen-containing compound, chloro paraffine, polybromo diphenyl oxide, polybromo diphenyl, dibromo neopentyl glycol, tetrabromo phthalic anhydride, and 4,4′-isopropylidene bis(2,6-dibromophenol) are preferred. Aluminum hydroxide or magnesium hydroxide is preferred as aforementioned metal hydroxide-containing compounds.

By coating the nonflammable compound on the separator, it is possible to restrain or relieve from burning in an abnormal use of the battery.

The coating solution further comprises an adhesive resin and a solvent. The adhesive resin is chemically and electrochemically stable material during charge/discharge reaction and used for bonding the nonflammable compound onto the separator. A composition for the aforementioned adhesive resin predominantly comprises at least one or mixture or copolymer selected from the group consisting of polyethylene oxide, polypropylene oxide, polyurethane, polymetamethyl acrylate, polycyano acrylate, polyethylene acrylic acid, polyacrylro nitrile, polyvinylidene fluoride, polyhexapropylene fluoride. Also, the available solvents are dimethyl carbonate, acetonitrile, tetrahydrofurane, acetone and methyl ethyl ketone.

The coating solution prepared by mixing 0.5 to 10 parts by weight of adhesive resin and 2 to 20 parts by weight of nonflammable compound in the solvent is coated in a thickness of 1 to 20 um on the surface of separator. Amounts in excess of 10 percent by weight of adhesive resin do not appear to provide any benefits in terms of ion mobility, on the other hand, in less than 0.5 percent by weight of that appear weak adhesion. Also, amounts in excess of 20 percent by weight of nonflammable compound prevent ion mobility, on the other hand, in less than 2 percent by weight of that appear weak heat-resistance.

Also, a lithium ion secondary battery according to the present invention comprises positive and negative electrodes, the separator which is positioned between positive and negative electrodes, lithium ion-containing electrolyte and the packaging material.

In order to form the positive electrode, the positive electrode active material prepared by dispersing lithium transition metal compound powder, graphite powder to assist electron transfer and binder for adhesion in the solvent is uniformly coated on the aluminum foil as a current collector, dried and densified with a roll presser.

In order to form the negative electrode, the negative electrode active material paste prepared by dispersing carbon powder, binder for adhesion and the additive in the solvent is uniformly coated on the copper foil as a current collector, dried and densified with a roll presser.

The following describes the method for producing a lithium ion secondary battery accordance with accompanying drawings. The method for producing a lithium ion secondary battery comprises steps as follows;

(1) a step of preparing electrodes by cutting to a prescribed size as shown in FIG. 1, and successively arranging them on the one side of aforementioned separator as following;

negative/positive/negative/negative/positive/positive/ . . . /negative/negative/positive/positive/negative

or

negative/negative/positive/positive/ . . . /negative/negative/positive/positive/negative

as shown in FIG. 2.

(2) a step of preparing the stack which is formed by winding consecutively the aforementioned electrode array and have a structure in which positive and negative electrodes are confronted each other on both sides of the separator as shown in FIG. 3. Subsequently, projecting terminals of positive and negative electrodes are welded in parallel by nickel and aluminum leads by using ultrasonic method.

(3) a step of housing the aforementioned electrode assembly into an aluminum laminating sheet, and subsequently introducing an electrolyte therein and sealing the packaging material.

The aforementioned electrolyte comprises a first compound, at least two material selected from the group consisting of ethylene carbonate, propylene carbonate, dimethyl carbonate, ethyl methyl carbonate, diethyl carbonate, vinylidene carbonate, γ-butylrolactone, and a second compound, at least one selected from the group consisting of LiCF₃SO₃, Li(CF₃SO₂)₂, LiPF₆, LiBF₄, LiClO₄, and LiN(SO₂C₂F₅)₂.

Also, as the packaging material, aluminum laminating sheet that is composed of aluminum and polymer layers or metal can that is made of iron or aluminum is preferred.

The present invention is described specifically with reference to examples and not by way of limitation.

### BRIEF DESCRIPTION OF THE DRAWINGS

The above and other objects and features of the present invention will become apparent from the following description of preferred embodiments taken in conjunction with the accompanying drawings, in which:

FIG. 1 is a sectional view showing the electrode cut to prescribed size, in which a projection is a current collector not covered with active material;

FIG. 2 shows that positive and negative electrodes are sequentially arrayed on one side of a separator;

FIG. 3 is a stack which is formed by winding consecutively the aforementioned electrodes array and has a structure that the positive and negative electrodes confront on both sides of separator;

FIG. 4 is a graph showing charge/discharge characteristics of the batteries of Examples 2 and Comparative Examples 1; and

FIG. 5 is a characteristic graph showing cycle life of the batteries of Examples 2 and Comparative Examples 1.

### DETAILED DESCRIPTION OF THE PREFERRED EMBODIMENT

### EXAMPLE 1

### Preparation of Separator

A rolled-up separator material, namely a porous polyethylene sheet (trade name Tecklon, manufactured by ENTEK, thickness of 25 μm) was unrolled. A mixture of dimethyl carbonate, polymetamethyl acrylate (average molecular weight 1,000,000) and dimethyl methyl phosphonate mixed at a ratio by weight of 100:5:5 was prepared as a coating solution. The separator was manufactured by coating one side of the sheet with a thickness of 5 μm of the coating solution using a liquid constant delivery apparatus.

### EXAMPLE 2

### Preparation of Battery (1)

A positive electrode was prepared by evenly mixing powder 100 g of LiCoO₂ as active material, 5 g of carbon black as conducting material and 5 g of polyvinylidene fluoride as binder, adding 100 ml of N-methylpyrrolidone to the mixture, coating the aluminum foil having a thickness of 15 μm to be used as a current collector with the resultant, thereafter drying and densifying it with a roll presser. As a result we obtained a positive electrode having a thickness of 150 μm.

A negative electrode was prepared by evenly mixing powder 100 g of graphite and 10 g of polyvinylidene fluoride as binder, adding 100 ml of N-methylpyrrolidone as a solvent to the mixture, coating the copper foil having a thickness of 10 um to be used as a current collector with the resultant, drying and densifying with a roll presser. As a result we obtained a negative electrode having a thickness of 150 μm.

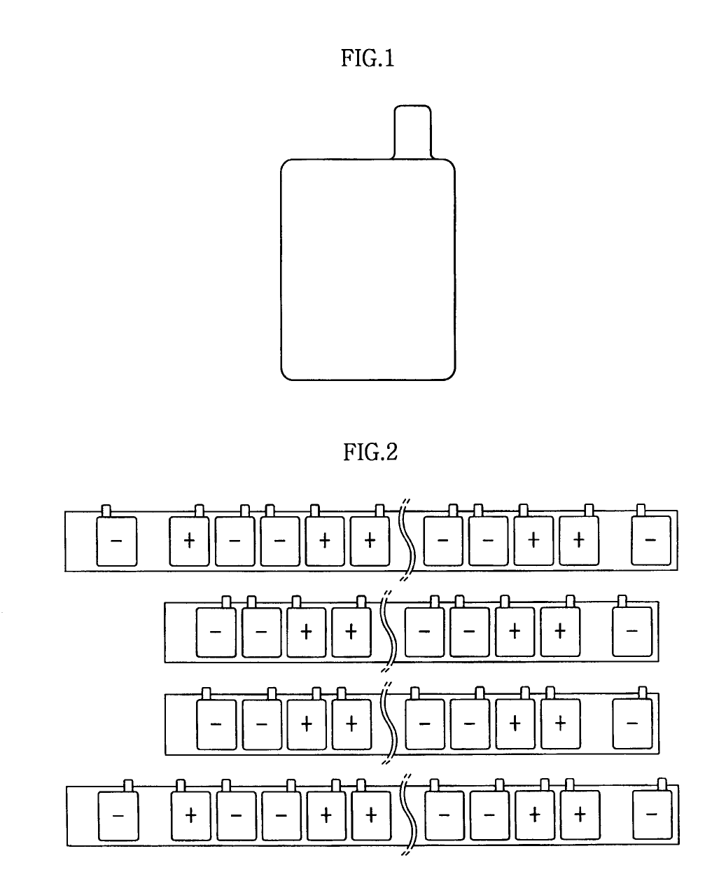

As shown in FIG. 1, the electrodes were prepared by cutting them to a prescribed size. The projection terminals thereof are current collectors which are not coated with active material. After that, electrodes were successively arranged on the one side of the separator prepared in example 1 as shown in FIG. 2, thereby forming a stack structure.

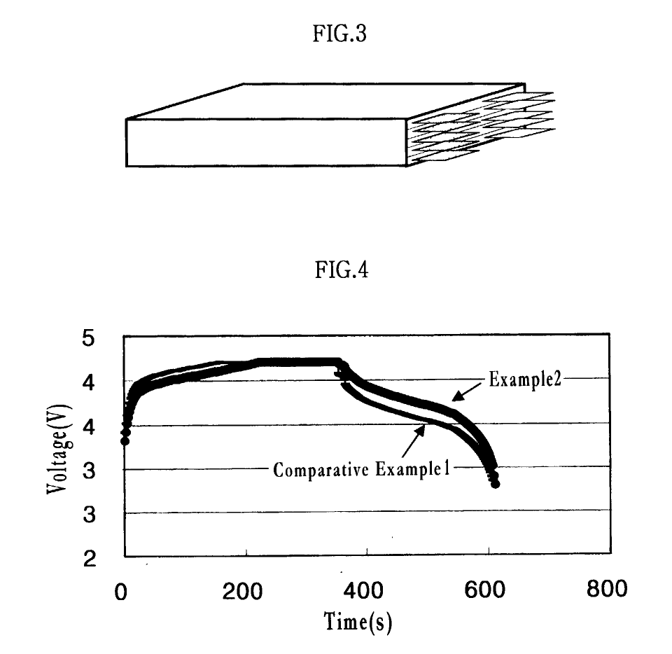

The stack structure has a configuration that positive and negative electrodes are confronted each other and the separator is positioned between positive and negative electrodes as shown in FIG. 3. The structure was achieved by winding consecutively the aforementioned electrode array. Subsequently, projecting terminals of positive and negative electrodes were welded in parallel by nickel and aluminum leads by using ultrasonic method.

The aforementioned stack was housed into an aluminum laminating sheet, subsequently introducing an electrolyte therein and sealing the pouch. The electrolyte was prepared by dissolving by 1.2 mol of LiPF₆ as the solute and 3 ml of solution of ethylene carbonate and dimethyl carbonate mixed at a ratio by volume of 2:1 as the solvent.

### EXAMPLE 3

### Preparation of Battery (2)

A lithium ion secondary battery was manufactured in the same manner as in Example 2 except that diphenyl cresyl phosphate was used as the nonflammable compound instead of dimethyl methylphosphonate, and polyurethane was used as the adhesive resin instead of polymetamethyl acrylate described in Example 1.

### EXAMPLE 4

### Preparation of Battery (3)

A lithium ion secondary battery was manufactured in the same manner as in Example 2 except that polyethylene oxide was used as adhesive resin instead of polymetamethyl acrylate described in Example 1.

### COMPARATIVE EXAMPLE

### Preparation of Prior Art Battery

A lithium ion secondary battery was manufactured in the same manner as in Example 2 except that a porous polyethylene (Celgard having a thickness of 25 μm) without nonflammable compound was used as separator, and jelly-roll method according to the conventional winding method with array of positive electrode/separator/negative electrode was used instead of stacking method as described in Example 2.

### TEST EXAMPLE 1

### Charge-Discharge Characteristics of Battery

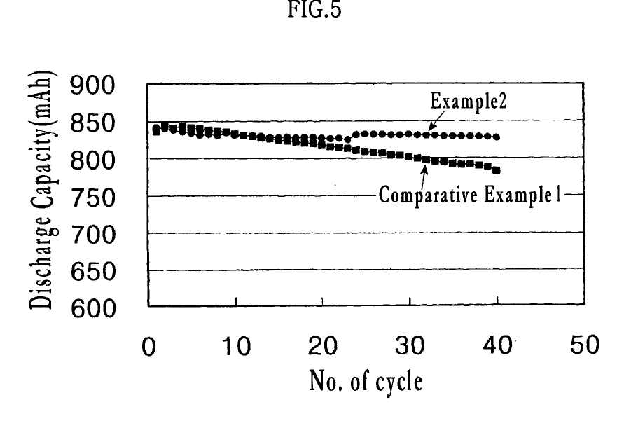

The charge/discharge characteristics of the batteries made by Examples 2 and Comparative Example were measured at 0.2 CmA rate. The test results are shown in FIG. 4. The charge/discharge characteristics of the battery according to Example 2 of the present invention shows improved performance compared with the battery made by Comparative Example. The reason is because the battery according to the Example 2 of the present invention forms a stable interface to reduce the internal resistance.

### TEST EXAMPLE 2

### Cycle Life of Battery

The cycle life of the batteries according to Example 2 and Comparative Example 1 were tested at 1 CmA rate. The test results are shown in FIG. 5. The battery according to Example 2 shows an improved cycle life characteristics as compared with the battery of Comparative Example.

In the test results, we appreciates that the discharge capacity of the battery according to Example 2 of the present invention is maintained over 95% of initial capacity after more than 40 cycles, on the other hand, that of the battery according to Comparative Example 1 reduces rapidly.

As described in the foregoing, the present invention provides the separator which is coated with nonflammable compound-containing polymer solution, and the lithium ion secondary batteries using the separator have improved safety and better performance such as charge/discharge characteristics and cycle life. Also, the lithium ion secondary battery can be manufactured with high yield in mass production by simple method than conventional method and have size flexibility by using an aluminum laminating sheet as packaging material.

What is claimed is:

1. A separator for a lithium secondary battery comprises;
a porous film including a polyolefin resin; and
a coating solution coated on the porous film and containing a nonflammable compound and an adhesive resin for fixing the nonflammable compound.

2. The separator for lithium ion secondary battery according to claim 1, wherein the adhesive resin comprises at least one material or mixture or copolymer selected from the group consisting of polyethylene oxide, polypropylene oxide, polyurethane, polymetamethyl acrylate, polycyano acrylate, polyethylene acrylic acid, polyacrylro nitrile, polyvinylidene fluoride and polyhexapropylene fluoride.

3. The separator for lithium ion secondary battery according to claim 1, wherein the nonflammable compound comprises at least one material or mixture selected from the group consisting of phosphorous-containing compound, halogen-containing compound, metal hydroxide-containing compound, antimony-containing compound, molybdenum-containing compound and zinc borate-containing compound.

4. The separator for lithium ion secondary battery according to claim 3, wherein the phosphorous-containing compound comprises at least one material or mixture selected from the group consisting of triethylene phosphate, dimethyl methyl phosphonate, diphenyl crecyl phosphate, tris-chloro-ethyl phosphate, diethyl-N,N-bis-(2-hydroxyethyl)-aminomethyl phosphonate and dibutyl dihydroxyethyl diphosphate.

5. The separator for lithium ion secondary battery according to claim 3, wherein the halogen-containing compound comprises at least one material or mixture selected from the group consisting of chloro paraffine, polybromo diphenyl oxide, polybromo diphenyl, dibromo neopentyl glycol, tetrabromo phthalic anhydride, and 4,4′-isopropylidene bis(2,6-dibromophenol).

6. The separator for lithium ion secondary battery according to claim 3, wherein the metal hydroxide-containing compound comprises at least one material or mixture selected from the group consisting of aluminum hydroxide and magnesium hydroxide.

7. The separator for lithium ion secondary battery according to claim 1, wherein the coating solution further comprises an ion conducting material and a solvent.

8. The separator for lithium ion secondary battery according to claim 7, wherein the adhesive resin comprises at least material or two members or copolymer selected from the group consisting of polyethylene oxide, polypropylene oxide, polyurethane, polymetamethyl acrylate, polycyano acrylate, polyethylene acrylic acid, polyacrylro nitrile, polyvinylidene fluoride, polyhexapropylene fluoride.

9. The separator for lithium ion secondary battery according to claim 7, wherein the solvent comprises at least material or mixture selected from the group consisting of dimethylcarbonate, acetonitrile, tetrahydrofurane, acetone and methylethyl ketone.

10. The separator for lithium ion secondary battery according to claim 1, wherein the coating solution is coated with a thickness of 1 to 20 μm on the surface of the separator.

11. A method for producing a separator for lithium ion secondary battery, comprising the steps of:
a step of preparing the coating solution by mixing 0.5 to 10 parts by weight of adhesive resin and 2 to 20 parts by weight of nonflammable compound in the solvent; and
a step of coating the coating solution on the one side surface of porous film composed of polyolefin group in a thickness of 1 to 20 μm

12. A lithium ion secondary battery comprising;
a positive electrode comprising a lithium transition metal oxide, carbon black and binder adhere to a current collector;
a negative electrode comprising carbon, graphite or transition metal oxide and binder adhere to a current collector;
a separator comprising porous film coated with nonflammable compound and adhesive resin;
an electrolyte comprising lithium-containing solute; and
a packaging material comprising aluminum or iron can or aluminum laminate sheet composed of aluminum and polymer layer;
wherein the internal structure of the lithium ion secondary battery is formed by cutting electrodes to a prescribed size and arranging successively on the one side of the separator as following;
negative/positive/negative/negative/positive/positive/ . . . /negative/negative/positive/positive/negative
or
negative/negative/positive/positive/ . . . /negative/negative/positive/positive/negative,
winding consecutively the electrode array, and making a stacked structure that positive and negative electrodes are confronted subsequently on both sides of the separator, and welding projecting terminals of positive and negative electrodes in parallel by metal strips respectively.

13. The lithium ion secondary battery according to claim 12, wherein the separator further comprises an ion conducting material and solvent.

14. The lithium ion secondary battery according to claim 12, wherein the lithium ion secondary battery is any one of liquid type battery, gel type polymer battery or solid type polymer battery.
